(19) United States
(12) Patent Application Publication
(10) Pub. No.: US 2009/0045190 A1
(43) Pub. Date: Feb. 19, 2009

(54) APPARATUS AND METHOD FOR THE MICROWAVE COOKING OF A FOOD PRODUCT

(76) Inventors: Laura GUTIERREZ, Sainte-Anne-des-Lacs (CA); Robert VILLENEUVE, Oka (CA)

Correspondence Address: BERESKIN AND PARR, 40 KING STREET WEST, BOX 401, TORONTO, ON, M5H 3Y2, CA

(21) Appl. No.: 12/191,660

(22) Filed: Aug. 14, 2008

Related U.S. Application Data
(60) Provisional application No. 60/935,460, filed on Aug. 14, 2007.

(51) Int. Cl. H05B 6/80; B65B 1/04

(52) U.S. Cl. 219/730; 53/473

(57) ABSTRACT

A cooking apparatus for microwave cooking of a food product, such as a breakfast sandwich, is disclosed. A kit comprising such an apparatus and such a food product is also disclosed. The apparatus includes a tray, a cover for the tray, and a susceptor sleeve. In a storage configuration, the food product can be located in the container formed by the assembled tray and cover such that the food product is displayed therein for the consumer to choose. In this configuration, the sleeve can be collapsed between the tray and the food product, within the container. Once it is desired to cook the food product, the cover can be removed and discarded or recycled, and the sleeve can be expanded so that the food product can be put therewithin. The sleeve and food product being positioned in the microwave oven (optionally on the tray) so that the heat provided thereby causes the food product to cook and grill/toast.

### CROSS-REFERENCE TO RELATED APPLICATION

The present application claims priority on U.S. provisional application No. 60/935,460 filed on Aug. 14, 2007.

### FIELD OF THE INVENTION

The present invention relates to food products and, more particularly, to the cooking of food products using microwave ovens. Such food products can be, for example, dough-based products such as sandwich food products.

### BACKGROUND OF THE INVENTION

Microwave ovens have been used for many years to cook, with more or less success, a large number of different food products. For instance, microwave ovens are efficient to heat liquids, but other food products do not cook properly or adequately with such devices. Indeed, products that include dough are difficult to cook with microwave ovens. Some products become soggy when cooked with microwave ovens, whereas others become very hard.

Various containers and cooking implements have been tried to cook food products so as to grill or toast some components thereof, such as breads, crusts, etc.

For instance, Canadian Patent Application No. 2,532,096, laid open on Jul. 7, 2006 in the name of Kraft Foods Holdings, Inc., discloses a pedestal and support cooking sheets for cooking microwavable dough products, wherein the pedestal is elevated from the floor of the microwave oven. Heated vapor is trapped within the open surface defined by the oven floor and the pedestal.

Also, Canadian Patent Application No. 2,567,994, laid open on May 22, 2007 in the name of Kraft Foods Holdings, Inc., describes a cooking apparatus for use with microwavable food products, which includes an elevated tray and a lid, both having susceptor surfaces in contact with the top and bottom surfaces of the food product. The lid is not attached to the tray so that it can displace vertically with changes in the thickness of the food product being cooked, such that the susceptor surface of the lid stays at least partly in contact with the top surface of the food product.

Furthermore, Canadian Patent Application No. 2,467,213, laid open on Nov. 22, 2004 in the name of Kraft Foods Holdings, Inc., teaches a susceptor tray with a susceptor surface of an elevated platform from which depends a downwardly extending portion that has sidewall functions and that traps heated vapor within an open surface defined by the susceptor tray. This is used to cook dough products in a microwave oven.

Therefore, it is desirable to provide a solution as an alternative to the existing technologies.

### SUMMARY OF THE INVENTION

According to one aspect there is provided a cooking apparatus for microwave cooking of a food product, the apparatus comprising:

a bottom tray adapted to support a food product;

a cover adapted to be detachably mounted on the bottom tray; and

a susceptor sleeve adapted to receive the food product, the susceptor sleeve comprising at least one inner susceptor surface,

the apparatus being adapted to adopt:

a storage configuration in which the cover is mounted on the bottom tray thereby defining an internal storing chamber dimensioned to receive the food product and the susceptor sleeve; and

a cooking configuration in which the susceptor sleeve is adapted to contain the food product. In such a cooking configuration, the bottom tray and/or can be non-participating or excluded and then can be discarded or recycled.

According to another aspect there is provided a cooking apparatus for microwave cooking of a food product, the apparatus comprising:

a bottom tray adapted to support a food product;

a cover adapted to be detachably mounted on the bottom tray; and

a foldable susceptor sleeve adapted to adopt a collapsed position and an expanded position in which the sleeve is adapted to receive the food product, the foldable susceptor sleeve comprising at least one inner susceptor surface,

the apparatus being adapted to adopt:

a storage configuration in which the cover is mounted on the bottom tray thereby defining an internal storing chamber dimensioned to receive the food product and the foldable susceptor sleeve; and

a cooking configuration in which the foldable susceptor sleeve is in the expanded position and adapted to receive the food product.

For example, the apparatus can be adapted to adopt a storage configuration in which the cover is mounted on the bottom tray thereby defining an internal storing chamber dimensioned to receive the food product and the foldable susceptor sleeve in the collapsed position. The apparatus can also be adapted to adopt a cooking configuration in which the foldable susceptor sleeve is in the expanded position and adapted to receive the food product, and in which the cover and optionally the bottom tray are excluded. They can eventually be discarded or recycled. The apparatus can also be adapted to adopt a cooking configuration in which the foldable susceptor sleeve is disposed on the bottom tray and is in the expanded position and adapted to receive the food product, and in which the cover is taken away.

According to another aspect there is provided a cooking apparatus for microwave cooking a food product, the cooking apparatus comprising a foldable susceptor sleeve adapted to adopt a collapsed position and an expanded position in which the sleeve is adapted to receive the food product, the foldable susceptor sleeve comprising at least one inner susceptor surface.

According to another aspect there is provided a method for packaging a food product comprising:

providing a cooking apparatus for microwave cooking the food product and comprising a foldable susceptor sleeve adapted to adopt a collapsed position during storage and an expanded position in which the sleeve is adapted to receive the food product therewithin when cooking, the foldable susceptor sleeve comprising at least one inner susceptor surface; and

depositing the foldable susceptor sleeve in the collapsed position between the food product and a portion of a food packaging container.

According to another aspect there is provided a method for microwave cooking a food product, the method comprising:

obtaining a foldable susceptor sleeve adapted to adopt a collapsed position and an expanded position in which the sleeve is adapted to receive the food product, the foldable susceptor sleeve comprising at least one inner susceptor surface; and

converting the foldable susceptor sleeve from the collapsed position to the expanded position, inserting therewithin the food product and cooking the food product in a microwave oven.

According to another aspect there is provided a food product kit comprising:

a food product; and

a cooking apparatus for microwave cooking said food product, said apparatus comprising:

a bottom tray adapted to support the food product;

a cover adapted to be detachably mounted on the bottom tray; and

a foldable susceptor sleeve adapted to adopt a collapsed position and an expanded position in which the sleeve is adapted to receive the food product therewithin, the foldable susceptor sleeve comprising at least one inner susceptor surface,

the apparatus being adapted to adopt:

a storage configuration in which the cover is mounted on the bottom tray thereby defining an internal storing chamber dimensioned to receive the food product and the foldable susceptor sleeve in the collapsed position; and

a cooking configuration in which the foldable susceptor sleeve is in the expanded position and adapted to receive the food product therewithin, and in which the cover and optionally the bottom tray are excluded.

In the previously mentioned apparatuses, methods and kits, the food product can be, for example, chosen from dough-based product such as sandwich food products. For example, the sandwich food products can be of various types such as breakfast sandwiches, paninis, traditional bread sandwiches or sandwiches made of various type of bread such as wraps, kaisers, English muffins, croissants, bagels, pitas, ciabattas, flat breads etc.

In the previously mentioned apparatuses, methods and kits, the susceptor sleeve can be a foldable sleeve. The foldable susceptor sleeve, can be in the expanded position, is in a generally parallelepiped shape. For example, it can be of a general parallelepiped shape and have two opposite open faces. The parallelepiped shape can be a rectangular prism or a cube. For example, the foldable susceptor sleeve, in the expanded position, can have two opposite open side faces, two opposite side walls, a bottom wall and a top wall.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a perspective view of a kit comprising a microwave cooking apparatus in combination with a food product, according to an illustrative embodiment of the present invention, the main components thereof being herein shown separately for illustration purposes, the apparatus being adapted for cooking the food product in a microwave oven;

FIG. 2 is a perspective view the kit comprising the apparatus and food product of FIG. 1, but shown in a packaged state or storage configuration for sale purposes;

FIG. 3 is a perspective view of a tray and of an overturned cover of the apparatus of FIG. 1;

FIG. 4 is a perspective view of the kit of FIG. 2, but with the cover of the apparatus being partly removed;

FIG. 5 is a perspective view of a susceptor sleeve of the apparatus, which is located atop the tray of the apparatus, with the food product being positioned within the susceptor sleeve for cooking purposes; and

FIG. 6 is a perspective view similar to FIG. 5, but without the tray.

### DETAILED DESCRIPTION OF ILLUSTRATIVE EMBODIMENTS

With reference to the appended drawings, an apparatus D according to an illustrative embodiment of the present invention and a food product F will now be described. A kit K comprising apparatus D in combination with food product F will also be described. The apparatus D doubles as a packaging for the food product F as well as a cooking unit for the food product F when heated in a microwave oven. The food product F is for instance a dough-based product such as a sandwich food product. For example, the sandwich food product can be a breakfast sandwich or the like.

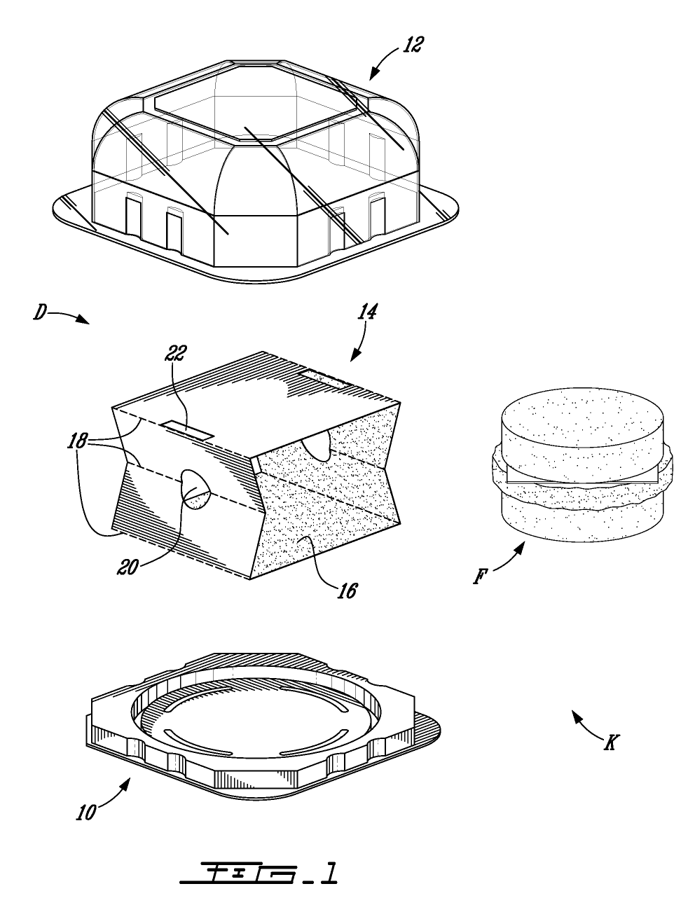

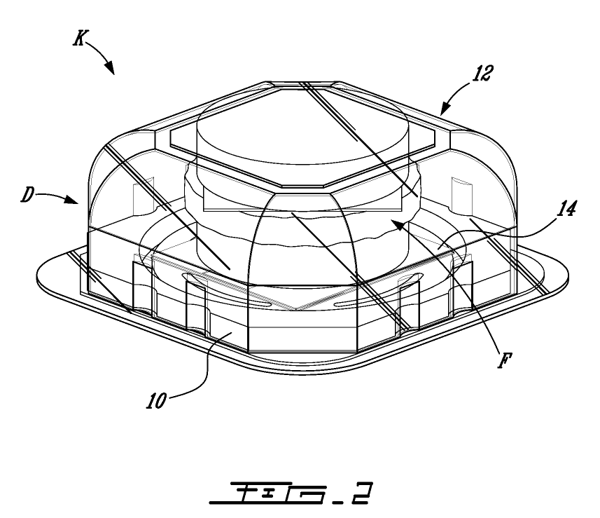

Referring to FIG. 1, apparatus D comprises a bottom tray 10, a cover 12 adapted to be detachably mounted to the tray 10 (as seen in FIG. 2), and a susceptor sleeve 14 having at least one inner susceptor surface 16. It can also comprise at least 2, 3, or 4 inner susceptor surfaces 16 as shown in FIG. 1. In FIG. 1, the inner surface of each walls (two side walls, one bottom wall and one top wall) comprise a susceptor surface. The tray 10 can comprise various microwavable or non-microwavable materials. The tray can be made of various polymers, papers, cardboards, etc. For example, as shown herein, the cover 12 can be transparent. The apparatus D can be in combination with a food product F (for example a breakfast sandwich) so as to form a sandwich food product kit K. They can also be separated. As shown in FIG. 1, the susceptor sleeve 14 can be a foldable susceptor sleeve and be provided with folding lines 18. It can also be non-foldable and being of a general parallelepiped shape as previously indicated. As shown in FIG. 1, the sleeve 14 can be provided with vent apertures 20 and 22. The food product F can optionally be wrapped with a food film.

The foldable susceptor sleeve 14, when being in the expanded position (see FIGS. 1, 5 and 6), can be in a generally parallelepiped shape. For example, it can be of a general parallelepiped shape and have two opposite open faces. The parallelepiped shape can be a rectangular prism or a cube. For example, the foldable susceptor sleeve, in the expanded position, can have two opposite open side faces, two opposite side walls, a bottom wall and a top wall. The person skilled in the art would understand that the expression a “generally parallelepiped shape” as used herein refers to regular parallelepiped shape having right angles but it also encompasses shapes having angles slightly different than right angles as shown in the sleeve 14 in FIGS. 1, 5 and 6. Such a sleeve has a trapezoidal aspect in view of angles slightly inferior to 90° but is encompased in the meaning of “generally parallelepiped shape”. The same angles could also be slightly superior to 90° and the sleeve would still be encompassed by the scope of the expression “generally parallelepiped shape”. The same also applies for the terms “rectangular prism” and “cube” previously mentioned

In FIG. 2, the apparatus D of kit K is shown in a storage configuration. Such a configuration serves as a packaging for the food product F and, more particularly, for storing and displaying the food product F. In this configuration, the susceptor sleeve 14 is in a collapsed position thereof and is located between the tray 10 and the food product F.

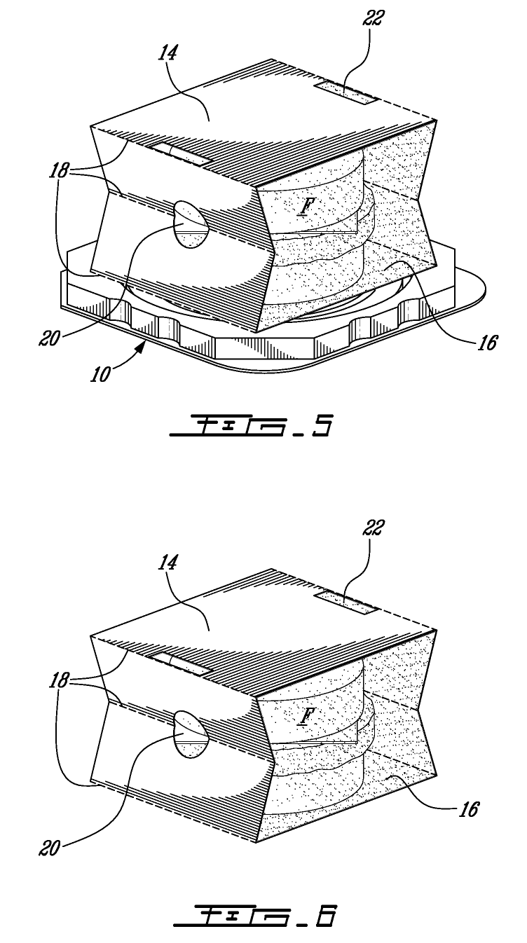

As shown in FIG. 2, the apparatus D is adapted to adopt a storage configuration in which the cover 12 is mounted on the bottom tray 10 thereby defining an internal storing chamber dimensioned to receive the sandwich food product F and the foldable susceptor sleeve 14 in the collapsed position. In FIG. 2, the foldable susceptor sleeve 14 is in the collapsed position and is disposed on the bottom tray 10 and the sandwich food product F is disposed on the foldable susceptor sleeve 14 in the collapsed position. Alternatively, the sleeve 14 could be in the expanded position when being in the storage position. Such a situation would be the equivalent of FIG. 5 but in a case where the cover 12 would be mounted on the tray 10. However, in such a situation, a considerable portion of the surface are of the food product can not be seen by the customer.

When using a transparent cover 12, the food product kit K is particularly interesting on a marketing point of view since a customer can see really well the food product as well as at least some of its constituents or its ingredients. Moreover, due to the fact that the susceptor sleeve is foldable it can be disposed between the tray 10 and the food product F and is thus considerably hidden by the food product. Therefore, when using such an apparatus for displaying the food product 10, the attention of the customer is really directed to the food product rather than to non-food and less attracting elements. This is particularly true for the customer which is desirous of visually analyzing the food before buying it or for an hungry customer. In fact, the apparatus D really permits to put the emphasis on the food rather than on the packaging elements. Such a kit and apparatus are thus really useful for rendering attractive a food product by exposing to a viewer, when being in a storing configuration, for example, at least 50, 60 or 70% of the total surface area of the food product. Such features render the kit K and apparatus D really interesting not only for the customers but also for food manufacturers, distributors, and retailers for example on a marketing point of view.

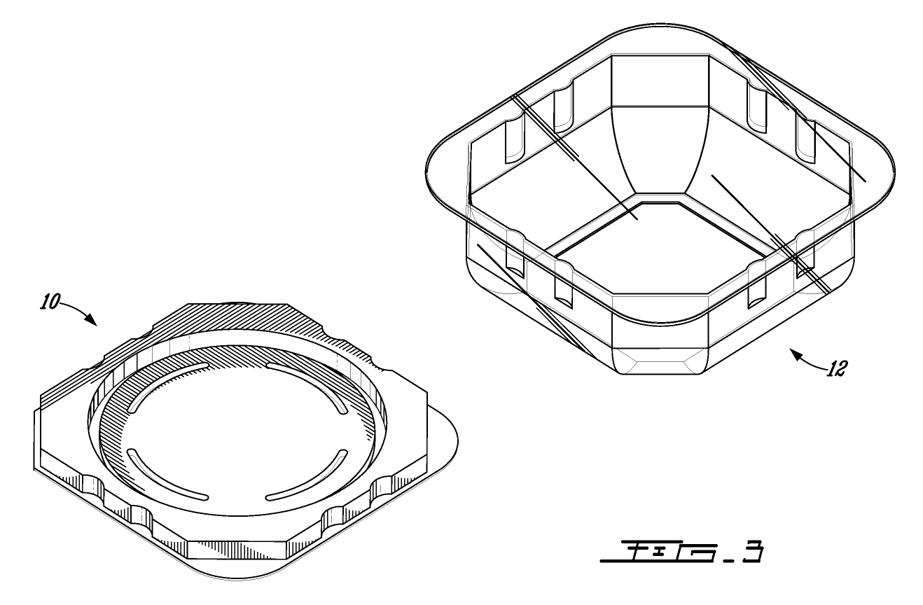

FIG. 3 shows the bottom tray 10 and the cover 12 in isolation. The cover 12 is herein adapted, via lower edges thereof, to frictionally (or with a snapping connection) engage the periphery of the tray 10 so as to provide a closed container for the food product F to be stored and displayed.

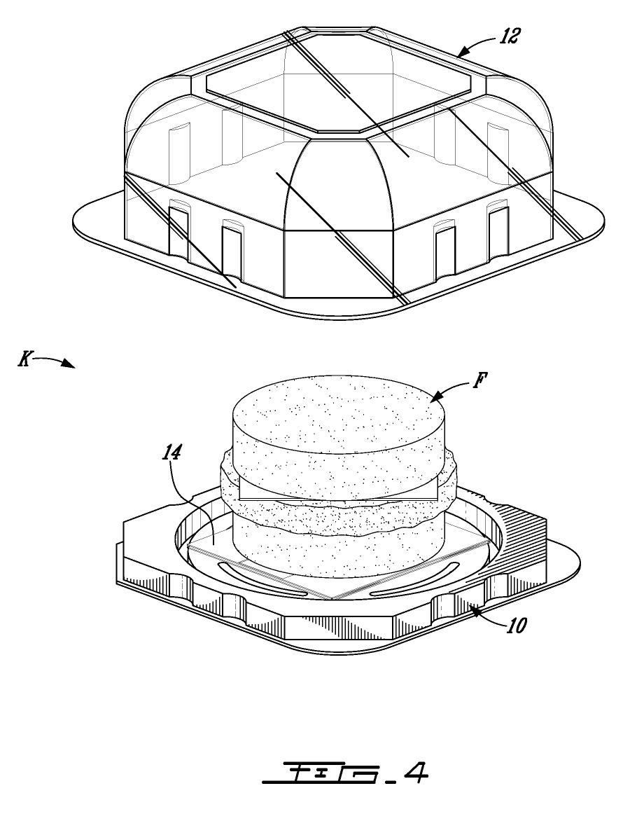

FIG. 4 shows the packaging of FIG. 2 but with the cover 12 being mostly removed from the tray 10.

FIG. 5 illustrates the susceptor sleeve 14 in an expanded position thereof and with the food product F disposed within the sleeve 14 and with the sleeve 14 sitting on the tray 10. Such a cooking configuration as shown in FIG. 5 is used, for example, when the tray 10 is a microwavable tray.

FIG. 6 is similar to FIG. 5, but without the tray 10. In fact, FIG. 6 shows a cooking configuration that can be used for example, when the tray is not a microwavable tray.

When the food product F is located in the susceptor sleeve 14 (see the cooking configurations of FIGS. 5 and 6) and is then heated in a microwave oven, it is cooked with the dough components of the food product F being grilled or toasted.

The kit K as shown in FIG. 1 can further comprises cooking instructions. For example, in a case where the tray is not a microwavable tray and wherein the food product is wrapped in a plastic film, these cooking instructions can be:

1. Remove the sandwich from the plastic wrap.

2. Open the sleeve and place the sandwich inside.

3. Place in microwave and cook on HIGH for 2 minutes.

4. Handle with caution, the product is very hot.

5. Let rest for 1 minute and then enjoy.

The kit K (or apparatus D) can also comprise a sticker or label disposed on a part thereof (for example the cover 12 and/or tray 10) so as to show a listing of the ingredients of the food product

The present kit K includes a breakfast sandwich as a food product F, which can be toasted/grilled when the arrangement of FIG. 5 or 6 is heated in a microwave oven. The apparatus D, when being in a cooking configuration (see FIGS. 5 and 6), uses the sleeve 14 and optionally the tray 10 and to grill/toast the dough-based food product F, whereas the food product is further packaged in the same tray 10 and the cover 12 with the sleeve 14 being, in such packaged position or collapsed position, mostly hidden, when the apparatus D is in storage configuration (see FIG. 2). When the apparatus D is in such a storage configuration, the sleeve 14 must thus be handled so that it can serve in the cooking of the food product F. In fact, the sleeve 14 is to be converted into its expanded position, and then the food product F can be inserted in the sleeve 14 and eventually in a microwave oven (with or without the tray 10) and cooked. Alternatively, the sleeve can be disposed in the microwave oven, then the food product F is inserted in the sleeve, and finally the product is cooked.

With the apparatus D, the food product F can be manufactured and distributed retail to end consumers, such as in convenience stores, grocery stores or vending machines. The consumer can visualize the food product F located in the apparatus D in its packaging/displaying configuration of FIG. 2, in view of the clear or transparent cover 12 and of the fact that the susceptor sleeve 14 is mostly hidden as being located in its collapsed position under the food product F. Once the consumer has chosen which food products he/she wishes to eat, he/she manipulates the apparatus so that the food product F is positioned as in FIG. 5 or 6 (depending if the tray is microwavable or not) before being put in the microwave oven where it will be grilled/toasted.

It was found that using a cooking apparatus as defined in the present document, a customer can easily and rapidly obtain a food product, such as a sandwich food product, which has the same crispy and browned aspects than a similar sandwich food product prepared in a restaurant. It is thus quite interesting for a customer to be able to prepare such a delicious sandwich at home, rapidly, and by using a microwave oven. Such an apparatus thus permits to a customer to save time and money. The customer can thus have, at home and at a lower cost, the same great taste than in a restaurant. It thus renders the previously mentioned apparatuses, methods and kits very interesting. The kits previously disclosed thus represent a very interesting item to sale, since it is simple, cheap to manufacture, and it allows to a customer to easily and rapidly prepare a good quality food product at low cost.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention. Indeed, various modifications thereof will be apparent to those skilled in the art without departing from the spirit and scope of the invention.

What is claimed is:

1. A sandwich food product kit comprising:
a sandwich food product; and
a cooking apparatus for microwave cooking said sandwich food product, said apparatus comprising:
a bottom tray adapted to support said sandwich food product;
a cover adapted to be detachably mounted on said bottom tray; and
a foldable susceptor sleeve adapted to adopt a collapsed position and an expanded position in which said sleeve is adapted to receive said sandwich food product therewithin, said foldable susceptor sleeve comprising at least one inner susceptor surface,
said apparatus being adapted to adopt:
a storage configuration in which said cover is mounted on said bottom tray thereby defining an internal storing chamber dimensioned to receive said sandwich food product and said foldable susceptor sleeve in said collapsed position; and
a cooking configuration in which said foldable susceptor sleeve is in said expanded position and adapted to receive said sandwich food product therewithin, and in which said cover and optionally said bottom tray are excluded.

2. The kit of claim 1, wherein said apparatus is adapted to adopt a storage configuration in which said cover is mounted on said bottom tray thereby defining an internal storing chamber dimensioned to receive said sandwich food product and said foldable susceptor sleeve in said collapsed position, and in which said foldable susceptor sleeve in said collapsed position is disposed on said bottom tray and said sandwich food product is disposed on said foldable susceptor sleeve in said collapsed position.

3. The kit of claim 2, wherein said cover is a transparent cover and wherein when said apparatus is in said storage configuration, a customer is able to see at least 50% of the total surface area said sandwich food product.

4. The kit of claim 1, wherein said apparatus is adapted to adopt a cooking configuration in which said foldable susceptor sleeve is disposed on said bottom tray and is in said expanded position and adapted to receive said sandwich food product, and in which said cover and said tray are discarded.

5. The kit of claim 1, wherein said apparatus is adapted to adopt a cooking configuration in which said foldable susceptor sleeve is disposed on said bottom tray and is in said expanded position and adapted to receive said sandwich food product, and in which said cover is discarded.

6. The kit of claim 1, wherein said bottom tray is a microwavable bottom tray.

7. The kit of claim 1, wherein said sandwich food product is a breakfast sandwich.

8. The kit of claim 1, wherein said sandwich food product is an English muffin breakfast sandwich.

9. The kit of claim 7, wherein said foldable susceptor sleeve is adapted to microwave cook said sandwich is such a manner to provide a cooked sandwich similar to a sandwich grilled or toasted served in a restaurant.

10. The kit of claim 1, wherein said foldable susceptor sleeve, in said expanded position, is in a generally parallelepiped shape.

11. The kit of claim 1, wherein said foldable susceptor sleeve, in said expanded position, is at least substantially in the form of a hollow rectangular prism or a cube having two opposite open side faces, two opposite side walls, a bottom wall and a top wall.

12. The kit of claim 11, wherein said top wall, said bottom wall, and said side walls each comprise an inner susceptor surface.

13. The kit of claim 11, wherein each of said side walls comprise a vent aperture and said top wall comprises at least one vent aperture.

14. The kit of claim 1, wherein said sandwich food product is wrapped in a food film product.

15. The kit of claim 1, further comprising cooking instructions.

16. A cooking apparatus for microwave cooking of a food product, said apparatus comprising:
a bottom tray adapted to support a food product;
a cover adapted to be detachably mounted on said bottom tray; and
a foldable susceptor sleeve adapted to adopt a collapsed position and an expanded position in which said sleeve is adapted to receive said food product, said foldable susceptor sleeve comprising at least one inner susceptor surface,
said apparatus being adapted to adopt:
a storage configuration in which said cover is mounted on said bottom tray thereby defining an internal storing chamber dimensioned to receive said food product and said foldable susceptor sleeve; and
a cooking configuration in which said foldable susceptor sleeve is in said expanded position and adapted to receive said food product.

17. The apparatus of claim 16, wherein said apparatus is adapted to adopt a storage configuration in which said cover is mounted on said bottom tray thereby defining an internal storing chamber dimensioned to receive said food product and said foldable susceptor sleeve in said collapsed position.

18. The apparatus of claim 17, wherein said apparatus is adapted to adopt a cooking configuration in which said foldable susceptor sleeve is in said expanded position and adapted to receive said food product, and in which said cover and optionally said bottom tray are excluded.

19. The apparatus of claim 16, wherein said foldable susceptor sleeve is adapted to microwave cook said food product is such a manner to provide a cooked food product similar to a food product grilled or toasted served in a restaurant.

20. A method for packaging a food product comprising:
providing a cooking apparatus for microwave cooking said food product and comprising a foldable susceptor sleeve adapted to adopt a collapsed position during storage and an expanded position in which said sleeve is adapted to receive said food product therewithin when cooking, said foldable susceptor sleeve comprising at least one inner susceptor surface; and
depositing said foldable susceptor sleeve in said collapsed position between said food product and a portion of a food packaging container.
